(19) United States
(12) Patent Application Publication
(10) Pub. No.: US 2005/0130546 A1
(43) Pub. Date: Jun. 16, 2005

(54) Manufacturing method and manufacturing apparatus for image display device

(76) Inventors: Masakuni Osoegawa, Tokyo (JP); Satoshi Koide, Tokyo (JP); Yuuji Kuwabara, Tokyo (JP); Kazuyuki Seino, Tokyo (JP); Hirotaka Murata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/050,226

(22) Filed: Feb. 4, 2005

Related U.S. Application Data
(63) Continuation of application No. PCT/JP03/09685, filed on Jul. 30, 2003.

(30) Foreign Application Priority Data
Aug. 5, 2002 (JP) 2002-227500
Aug. 5, 2002 (JP) 2002-227682

(51) Int. Cl. H01J 9/44; H01J 9/00; H01J 9/24

(52) U.S. Cl. 445/6; 445/24; 445/3

(57) ABSTRACT

At least one substrate, a front substrate or a rear substrate, is opposed to a processing electrode in a vacuum atmosphere, and an electric field is applied between the at least one substrate and the processing electrode, whereby the substrate is electric field-processed. After the electric field processing, the front substrate and the rear substrate kept in the vacuum atmosphere are sealed together to form an envelope.

### CROSS-REFERENCE TO RELATED APPLICATIONS

This is a Continuation Application of PCT Application No. PCT/JP03/09685, filed Jul. 30, 2003, which was published under PCT Article 21(2) in Japanese.

This application is based upon and claims the benefit of priority from prior Japanese Patent Applications No. 2002-227500, filed Aug. 5, 2002; and No. 2002-227682, filed Aug. 5, 2002, the entire contents of both of which are incorporated herein by reference.

### BACKGROUND OF THE INVENTION

1. Field of the Invention

The present invention relates to a manufacturing method and a manufacturing apparatus for an image display device provided with a pair of substrates opposed to each other.

2. Description of the Related Art

In recent years, flat image display devices have started to be developed as a next generation of image display devices. In these devices, a large number of electron emitting elements are arranged side by side and opposite to a phosphor screen. There are electron emitting elements of various types, all of which basically use field emission. A display device that uses these electron emitting elements is generally called a field emission display (hereinafter referred to as FED). Among FEDs, a device which uses surface-conduction electron emitting elements is also called a surface-conduction electron emission display (hereinafter referred to as SED). In the description hereof, however, the term FED is used as a general term for the displays of this type including SEDs.

An FED generally has a front substrate and a rear substrate that are opposed to each other with a given gap between them. These substrates have their respective peripheral edge portions joined together by a sidewall in the form of a rectangular frame, thereby constituting a vacuum envelope. The interior of the vacuum envelope is kept at a high degree of vacuum of about 10⁻⁴ Pa or below. A plurality of support members are arranged between the rear substrate and the front substrate in order to support atmospheric load that acts on these substrates.

A metal back and a phosphor screen, which includes red, blue, and green phosphor layers, are formed on the inner surface of the front substrate. A large number of electron emitting elements for emitting electrons that excite the phosphors to luminescence are provided on the inner surface of the rear substrate. A large number of scanning lines and signal lines are formed in a matrix and connected to the electron emitting elements, individually. A region in which these electron emitting elements are formed, as viewed macroscopically, is referred to as an electron emitting surface. An anode voltage is applied to the phosphor screen, and electron beams emitted from the electron emitting elements are accelerated by the anode voltage as they hit the phosphor screen, thereby causing the phosphors to glow and display a video image.

In the FED, a metal having gas adsorption properties, called a getter, is vapor-deposited (for getter flashing) on the metal back, in order to adsorb residual gas in the envelope and gas that is released from the substrates.

In the FED of this type, the gap between the front substrate and the rear substrate can be set to about 1 to 3 mm. When compared with a cathode ray tube (CRT) that is used as a display of an existing TV or computer, therefore, the FED can be made much lighter in weight and thinner.

In order to obtain practical display characteristics with the FED described above, a CRT phosphor with high luminous efficiency and good color purity should be used in consideration of luminance, color reproducibility, phosphor degradation, etc. Further, a thin aluminum film called a metal back must be formed on the phosphor screen. The anode voltage that is applied to the phosphor screen is expected to be set to several kV at the least, and preferably to 10 kV or more.

These FEDs glow when electron beams hit the phosphor. As this is done, plenty of released gas is produced and lowers the degree of vacuum in each FED, thereby damaging the electron emitting elements that are formed on the rear substrate. It is known, in consequence, that the electron emission properties of the electron emitting elements are degraded, luminance is lowered, color reproducibility is decayed, and life is shortened. If the luminance, a display characteristic, of the FED is expected to be increased, more electron beams must be emitted from the electron emitting elements, and this tendency develops. Thus, it is hard to realize a long-life image display device with excellent display performance.

To cope with this, the amount of released gas in the FED as a finished product must be reduced. Conventionally, a degassing effect is obtained by subjecting the front substrate and the rear substrate to high-temperature treatment before they become finished products. Since the high-temperature treatment is followed by a time during which the front substrate and the rear substrate are moved and detained in the open air, the gas is then adsorbed again, so that a satisfactory effect cannot be obtained.

In a method of absorbing the released gas in the FED, moreover, Ti, Ba or other metal that has high gas adsorption properties is located on the phosphor screen of or around the front substrate and used to adsorb the released gas, whereby the degree of vacuum in the FED is maintained. However, these materials have their respective allowable amounts of gas adsorption, and lose their efficacies for an amount of gas that exceeds a certain value. Thus, it is hard to maintain the properties for a prolonged time. Further, dust is produced in a sealing process for getter film formation, or the getter film chips owing to insufficient adhesion strength between the metal back and the getter film.

In consideration of resolution, electron emission efficiency, and other properties, on the other hand, the gap between the front substrate and the rear substrate cannot be made very large, and must be set to about 1 to 3 mm. In the FED, therefore, a strong electric field is inevitably formed in the small gap between the front substrate and the rear substrate, and electric discharge (dielectric breakdown) between the two substrates arouses a problem. If electric discharge occurs, a current of 100 A or more flows instantaneously, whereupon the electron emitting elements and the phosphor screen are broken or degraded. In some cases, electric discharge may break a driver circuit for operating the FED. These troubles will be referred to collectively as discharge-derived damages.

The discharge-derived damages cause fatal failures, such as a loss of information caused by the generation of non-display regions, lowering of luminance and color reproducibility, and degradation of display performance attributable to the degraded electron emitting elements, and naturally shorten the life of the image display device. In order to put the FED into practical use, therefore, these damages must be prevented for a long period of time. However, it is very difficult to suppress electric discharge completely.

On the other hand, there is a countermeasure not to prevent electric discharge but to suppress the scale of electric discharge, if any, so that the influence of the electric discharge on the electron emitting elements can be ignored. A technique associated with this concept is described in Jpn. Pat. Appln. KOKAI Publication No. 2000-311642, for example. According to this technique, a metal back on a phosphor screen is notched to form a pattern, such as a zigzag pattern, whereby the effective inductance and resistance of the phosphor screen are enhanced. A technique for dividing the metal back is described in Jpn. Pat. Appln. KOKAI Publication No. 10-326583. Described in Jpn. Pat. Appln. KOKAI Publication No. 2000-251797, moreover, is a technique in which divided sections are provided with a coating of an electrically conductive material in order to suppress creeping discharge at the divided sections.

Even if these techniques are used, however, it is hard completely to suppress the discharge-derived damages.

In general, voltage (hereinafter referred to as discharge voltage) that is produced by electric discharge is subject to variation. In some cases, electric discharge may occur after prolonged use of the FED. Suppressing electric discharge implies completely arresting electric discharge when the anode voltage is applied or lowering the probability of electric discharge to a practically allowable degree. An applicable anode-cathode potential difference will be referred to as withstand voltage.

There are various factors that cause electric discharge. A first triggering factor is emission of electrons from fine projections, foreign matter, etc. on the cathode side. A second triggering factor is collision of particulates that adhere to the cathode or anode or their partial exfoliations on opposite surfaces. In the FED, in particular, the metal back, a fragile film, and the getter film are lapped on the phosphor screen, so that their partial detachment may possibly trigger electric discharge.

Further, the getter film is formed as a vapor-deposited film on the metal back in a manner such that Ba, Ti or other metal that has high gas adsorption properties is fixed to a metal that serves as a base of the getter and the metal base is heated. As this is done, a part of the metal base and a part of the getter electrode may possibly melt in a vapor deposition process, in which the metal base is heated, and fall onto the front substrate and the rear substrate. They constitute sources of electric discharge that enhance electric discharge.

A method called conditioning is a well-known technique for improving withstand voltage. This method is described on page 302 of Electric Discharge Handbook (Ohmsha, Ltd., 1998), for example. In this method, a potential difference is applied between the opposite surfaces to improve the withstand voltage. It may cause electric discharge in some cases, and may not in other cases. In a strict sense, spark conditioning that causes electric discharge (spark) sometimes may be called conditioning. The details of the mechanism in which the withstand voltage is improved by the spark conditioning are unknown. However, the withstand voltage is supposed to be improved because sources of electric discharge, such as fine projections, foreign matter, etc., are melted and removed by electric discharge or because adhering particulates are removed by an electric field.

For example, a CRT is generally subjected to processing such that a pulse voltage about four times as high as an operating voltage is applied between electrodes of an electron gun, thereby causing electric discharge a thousand times. This is equivalent to the spark conditioning.

If the FED is subjected to such spark conditioning, however, the phosphor screen or electron emitting elements are broken or degraded inevitably. Therefore, this method cannot be simply applied to the FED.

Other measures to improve withstand voltage than the conditioning may include optimization of the material, construction, and manufacturing processes, cleaning of the manufacturing environment, washing, air blowing, etc. However, it is difficult for only these countermeasures to raise the withstand voltage to a desired value, so that there is an urgent demand for more effective measures to improve the withstand voltage. Also in view of cost reduction, moreover, it is not desirable to increase the cleanness to a very high degree or thoroughly remove particulates.

For the FED, as described above, maintenance of a high internal vacuum and a measure to counter electric discharge are essential considerations. Although high-temperature baking is carried out in a vacuum to degas a structure such as a phosphor screen, therefore, it is hard to obtain a satisfactory degassing effect. If an anode voltage as an operating voltage is lowered or if a gap between a front substrate and a rear substrate is increased, in order to prevent occurrence of electric discharge, luminance, resolution, and other performances must inevitably be sacrificed. It is difficult, therefore, to fulfill desired performance requirements for the product. Since the FED is sealed in a vacuum atmosphere, there is no means for removing foreign matter that adheres to the front substrate and the rear substrate as they are put into a vacuum tank or dust that is produced by getter flashing.

### BRIEF SUMMARY OF THE INVENTION

The present invention has been made in order to solve these problems, and its object is to provide a manufacturing method and a manufacturing apparatus for an image display device, capable of manufacturing an image display device that enjoys high voltage resistance and outstanding display performance and reliability.

In order to achieve the object, according to an aspect of the present invention, there is provided a method of manufacturing an image display device, which has a front substrate having a phosphor screen formed thereon and a rear substrate provided with a plurality of electron emitting elements, the method comprising: opposing at least one of the front and rear substrates to a processing electrode in a vacuum atmosphere and applying an electric field between the at least one substrate and the processing electrode, thereby electric field processing the at least one substrate; and sealing together the front substrate and the rear substrate kept in the vacuum atmosphere after the electric field processing.

According to another aspect of the invention, there is provided a method of manufacturing an image display device, which has a front substrate having a phosphor screen formed thereon and a rear substrate provided with a plurality of electron emitting elements, the method comprising: opposing the front substrate and a processing electrode having an aperture portion to each other in a vacuum atmosphere and applying an electric field between the front substrate and the processing electrode, thereby electric field processing the front substrate; and sealing together the front substrate and the rear substrate kept in the vacuum atmosphere after the electric field processing.

According to an aspect of the invention, there is provided an apparatus for manufacturing an image display device, which has a front substrate having a phosphor screen formed thereon and a rear substrate provided with a plurality of electron emitting elements, the apparatus comprising: a vacuum chamber of which the interior is kept in a vacuum and which stores at least one of the front and rear substrates; a processing electrode located opposite to the at least one substrate in the vacuum chamber; an electric field applying section which applies an electric field between the at least one substrate and the processing electrode; and a getter device which is provided in the vacuum chamber and forms a getter film on the at least one substrate.

According to another aspect of the invention, there is provided an apparatus for manufacturing an image display device, which has a front substrate having a phosphor screen formed thereon and a rear substrate provided with a plurality of electron emitting elements, the apparatus comprising: a vacuum chamber of which the interior is kept in a vacuum and which can store the front substrate; a processing electrode located opposite to the front substrate in the vacuum chamber; and an electric field applying section which applies an electric field between the front substrate and the processing electrode.

According to the method and the apparatus for manufacturing the image display device arranged in this manner, an electric field is applied to the substrate and the processing electrode located opposite to the substrate in the vacuum atmosphere, whereby electric field processing is effected. By doing this, foreign matter, projections, etc. that are left on the substrate can be removed to eliminate causes of generation of electric discharge. Thus, the image display device can be manufactured ensuring outstanding withstand voltage characteristics and improved display performance and reliability.

### BRIEF DESCRIPTION OF THE SEVERAL VIEWS OF THE DRAWING

FIG. 1 is a perspective view showing an example of an FED manufactured by a manufacturing method and a manufacturing apparatus according to a first embodiment of this invention;

FIG. 2 is a sectional view of the FED taken along line II-II of FIG. 1;

FIG. 3 is a sectional view schematically showing the manufacturing method and the manufacturing apparatus according to the first embodiment of the present invention;

FIG. 4 is a sectional view schematically showing a manufacturing method and a manufacturing apparatus according to a second embodiment of the present invention;

FIG. 5 is a sectional view schematically showing a manufacturing method and a manufacturing apparatus according to a third embodiment of the present invention;

FIG. 6 is a sectional view schematically showing a manufacturing method and a manufacturing apparatus according to a fourth embodiment of the present invention;

FIG. 7 is a sectional view schematically showing a manufacturing method and a manufacturing apparatus according to a fifth embodiment of the present invention;

FIG. 8 is a sectional view schematically showing a manufacturing method and a manufacturing apparatus according to a sixth embodiment of the present invention;

FIG. 9 is a sectional view schematically showing a manufacturing method and a manufacturing apparatus according to a seventh embodiment of the present invention; and

FIG. 10 is a sectional view schematically showing a manufacturing method and a manufacturing apparatus according to an eighth embodiment of the present invention.

### DETAILED DESCRIPTION OF THE INVENTION

Methods and apparatuses for manufacturing image display devices according to embodiments of this invention will now be described in detail with reference to the drawings.

First, an FED that is provided with surface-conduction electron emitting elements will be described as an example of an image display device that is manufactured by the manufacturing method and the manufacturing apparatus.

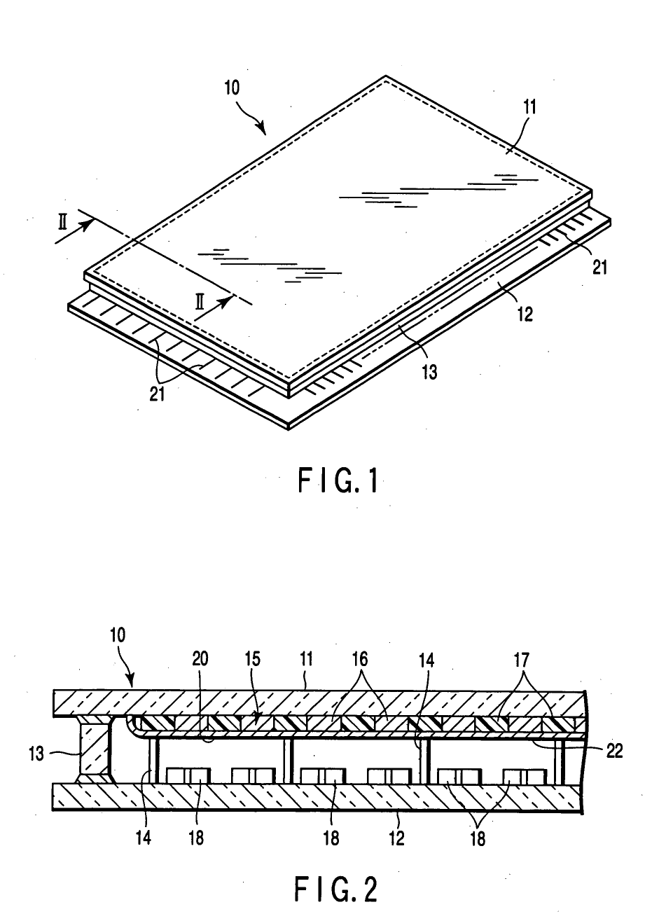

As shown in FIGS. 1 and 2, this FED comprises a front substrate 11 and a rear substrate 12, which are each formed of a rectangular glass plate as an insulating substrate having a thickness of about 1 to 3 mm. These substrates are opposed to each other with a gap of about 1 to 2 mm between them. The front substrate 11 and the rear substrate 12 have their respective peripheral edge portions joined together by a sidewall 13 in the form of a rectangular frame, and constitute a flat, rectangular vacuum envelope 10 that is internally kept in a high vacuum of about 10⁻⁴ Pa.

In order to support atmospheric load that acts on the front substrate 11 and the rear substrate 12, a plurality of spacers 14 are provided in the vacuum envelope 10. Sheetlike or columnar spacers or the like may be used as the spacers 14.

A phosphor screen 15 is formed as a phosphor screen on the inner surface of the front substrate 11. It has red, green, and blue stripe-shaped phosphor layers 16 and a matrix-shaped black light absorbing layer 17. The phosphor layers 16 may alternatively be dot-shaped. A metal back 20, which is formed of an aluminum film or the like, is formed on the phosphor screen 15, and moreover, a getter film 22 is lapped on the metal back.

A large number of surface-conduction electron emitting elements 18 that individually emit electron beams are provided on the inner surface of the rear substrate 12. They serve as electron sources that excite the phosphor layers 16 of the phosphor screen 15. These electron emitting elements 18 are arranged in a plurality of columns and a plurality of rows corresponding individually to pixels. Each electron emitting element 18 includes an electron emitting portion (not shown), a pair of electrodes that apply voltage to the electron emitting portion, etc. A large number of wires 21 for supplying potential to the electron emitting elements 18 are arranged in a matrix on the inner surface of the rear substrate 12, and their respective end portions are drawn out of the vacuum envelope 10.

In displaying an image on the FED of this type, an anode voltage is applied to the phosphor screen 15 and the metal back 20, and electron beams emitted from the electron emitting elements 18 are accelerated by the anode voltage as they hit the phosphor screen. Thereupon, the phosphor layers 16 of the phosphor screen 15 are excited to glow and display a color image.

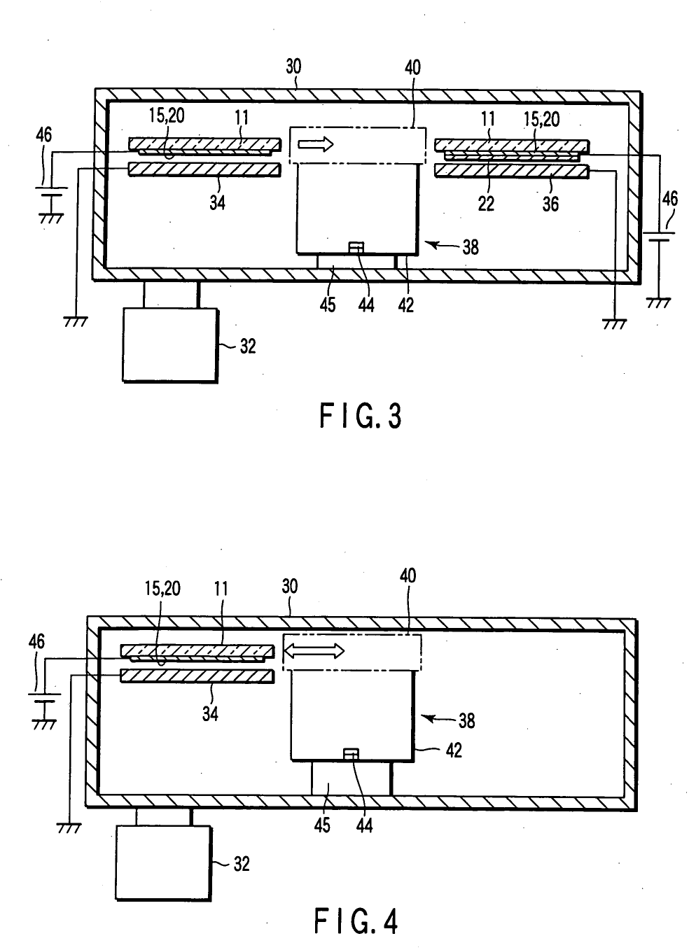

The following is a description of the manufacturing apparatus and the manufacturing method for the FED constructed in this manner. As shown in FIG. 3, the manufacturing apparatus is provided with a vacuum chamber 30 that is formed of a vacuum processing tank, and the vacuum chamber is connected with an exhaust pump 32 that evacuates its interior.

A first processing electrode 34, second processing electrode 36, and getter device 38 are disposed in the vacuum chamber 30. The first and second processing electrodes 34 and 36 are formed each in the shape of a plate that is substantially equal in size to the substrate to be processed. The first and second processing electrodes 34 and 36 are arranged substantially horizontally and with a gap between them. The first and second processing electrodes 34 and 36 are individually connected to the ground potential.

A getter vapor deposition position 40 is defined between the first and second processing electrodes 34 and 36, and the getter device 38 is located under the getter vapor deposition position 40. The getter device 38 comprises a cover 42 that opens toward the getter vapor deposition position 40, a getter material 44 provided on a bottom part in the cover, and a heating mechanism 45 for heating the getter material. A heating mechanism of the high-frequency heating type or resistance heating type may be used as the heating mechanism 45.

The manufacturing apparatus is provided with a power source 46 and a substrate transportation mechanism (not shown). The power source 46 applies voltage to the substrate to be processed. In the vacuum chamber 30, the substrate transportation mechanism transports the substrate between a first electric field processing position where the substrate faces the first processing electrode 34 and a second electric field processing position where it faces the getter vapor deposition position 40 and the second processing electrode 36.

The following is a description of a method of processing the substrate by the manufacturing apparatus. In the case described below, the substrate to be processed is the front substrate 11 on which the phosphor screen 15 and the metal back 20 are formed.

First, as shown in FIG. 3, the interior of the vacuum chamber 30 is evacuated to a desired degree of vacuum by the exhaust pump 32, whereupon a vacuum atmosphere is formed in the vacuum chamber. Subsequently, the front substrate 11 is carried into the vacuum chamber 30 and set in the first electric field processing position. In this first electric field processing position, the entire surface of the front substrate 11 on the side of the metal back 20 is opposed to the first processing electrode 34 with a desired gap between them.

Then, the power source 46 that serves as an electric field applying section is connected electrically to the metal back 20, and voltage is applied from the power source 46 to the metal back. The voltage applied to the metal back 20 is set so that a positive or negative potential difference is caused between the metal back and the first processing electrode 34. Thereupon, an electric field is generated between the front substrate 11 and the first processing electrode 34, and the front substrate 11 is field-processed. By this electric field processing, foreign matter, such as dust, having so far been left on the front substrate 11 is adsorbed and removed by the first processing electrode 34, and useless projections and the like that are formed in the process of production of the front substrate are removed.

After the electric field processing is completed, the front substrate 11 is transported to the getter vapor deposition position 40 without failing to keep the potential difference and the space between the first processing electrode 34 and the front substrate. By maintaining the potential difference in this manner, the foreign matter adsorbed by the first processing electrode 34 or the removed projections can be held on the first processing electrode lest they adhere again to the front substrate 11.

In the getter vapor deposition position 40, the front substrate 11 faces a top opening of the cover 42 of the getter device 38 with its surface on the side of the metal back 20 downward. In this state, the getter material 44 on the bottom part of the cover 42 is heated to be vaporized by the heating mechanism 45, whereby getter flashing is performed. In this manner, the getter is vapor-deposited to form the getter film 22 on the metal back 20 of the front substrate 11. If the getter flashing is effected from bottom to top using the getter material 44 that is situated below the front substrate 11, dust or the like that is produced by the getter flashing can be prevented from adhering to the front substrate 11.

After the getter film 22 is formed, the front substrate 11 is transported from the getter vapor deposition position 40 to the second electric field processing position without disconnecting the power source 46. In the second electric field processing position, the entire surface of the front substrate 11 on the side of the getter film 22 is opposed to the second processing electrode 36 with a desired gap between them.

Subsequently, voltage is applied from the power source 46 to the metal back 20 and the getter film 22. The applied voltage is set so that a positive or negative potential difference is caused between the front substrate 11 and the second processing electrode 36. Thereupon, an electric field is generated between the front substrate 11 and the second processing electrode 36, and the front substrate 11 is field-processed again. By the electric field processing, foreign matter, such as dust, adhering to the front substrate, including dust that is produced in the getter vapor deposition process or suspended matter in the vacuum chamber 30, is adsorbed and removed by the second processing electrode 36, and useless projections and the like that are formed on the front substrate in the getter vapor deposition process are removed.

Thereafter, the front substrate 11 is moved away from the second processing electrode 36 without failing to keep the potential difference between the front substrate 11 and the second processing electrode 36 and the distance from the processing electrode 34. On the other hand, the rear substrate 12, on which the wires 21, electron emitting elements 18, etc. are formed, is electric field-processed by the same aforesaid processes except the getter vapor deposition. However, the rear substrate 12 must only be electric field-processed at least once.

The electric field-processed front and rear substrates 11 and 12 are transported to a sealing position (not shown) in a manner such that they are kept in a vacuum atmosphere without being exposed to the open air, and are then sealed together to form the vacuum envelope 10. Thereupon, the vacuum envelope of the FED is completed. The substrates may be sealed either in the same vacuum chamber as the vacuum chamber 30 for the aforesaid electric field processing or in another vacuum chamber that communicates with the vacuum chamber 30 in a vacuum state.

According to the manufacturing method and the manufacturing apparatus arranged in this manner, dust or other foreign matter adhering to the front substrate 11 and the rear substrate 12 before the substrates are put into the vacuum chamber, and useless projections and the like that are formed in the process of production of the front substrate and the rear substrate can be removed, moreover, foreign matter, such as dust, adhering to the substrates, including dust that is produced in the getter vapor deposition process or suspended matter in the vacuum chamber, can be removed. Accordingly, factors that trigger generation of electric discharge can be removed, so that the FED with improved withstand voltage characteristics can be obtained. After the electric field processing of the front substrate and the rear substrate and the getter vapor deposition process are carried out in the vacuum chamber, in particular, the vacuum envelope is formed by sealing these substrates together without exposing them to the open air. Thus, suppression of initial electric discharge and prolonged electric discharge can be realized without the possibility of dust or the like in the open air adhering again to the substrates.

In consequence, breakdown and degradation of a phosphor screen and electron emitting elements and breakdown of a driver circuit can be prevented from being caused by electric discharge, so that the reliability and life performance of the FED can be improved. At the same time, the anode potential can be set higher, so that the FED can be obtained having high luminance and high display performance.

According to the first embodiment described above, the processing electrodes are provided individually before and behind the getter device 38. As in a second embodiment shown in FIG. 4, however, they may be replaced with a single processing electrode with the same result. After a front substrate 11 is electric field-processed by a processing electrode 34, in this case, the front substrate is transported to the getter vapor deposition position 40 to be subjected to getter vapor deposition. Thereafter, the front substrate 11 is returned to the position where it faces the processing electrode 34 again, and the electric field processing is performed.

Functions and effects similar to those of the foregoing first embodiment can be obtained with this arrangement, and the manufacturing apparatus can be simplified.

As in a third embodiment shown in FIG. 5, only one processing electrode 34 may be used so that a front substrate 11 can be transported to an electric field processing position where it faces the processing electrode 34, to be field-processed, only after a getter film is formed. Also in this case, the getter film 22 that is finally exposed in a vacuum envelope and faces a rear substrate 12 is electric field-processed, whereby dust or other foreign matter adhering to the getter film and useless projections and the like that are formed in the manufacturing process can be removed. In consequence, the withstand voltage characteristics of an FED can be fully improved.

Alternatively, only one processing electrode may be used so that electric field processing is performed only before the getter film is vapor-deposited. Also in this case, the withstand voltage characteristics can be improved.

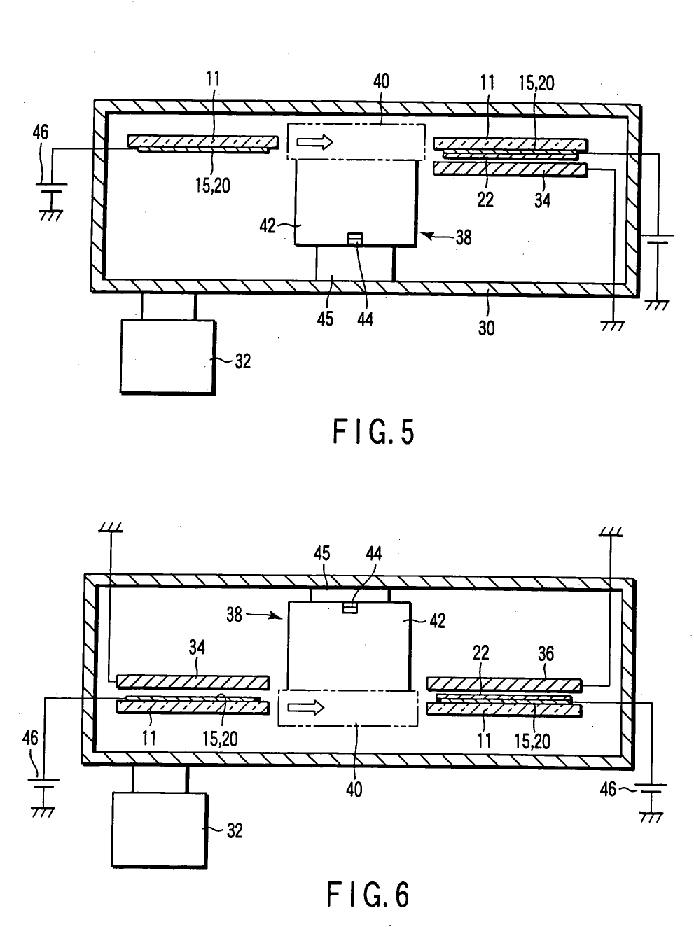

In the embodiments described above, moreover, dust that is produced by getter flashing is restrained from adhering to a substrate by effecting the getter flashing from bottom to top using a getter material that is situated below the substrate. As in a fourth embodiment shown in FIG. 6, however, a getter device 38 that includes a getter material 44 may be located above the substrate to be processed so that the getter flashing can be effected from top to bottom. It is to be understood that the getter flashing is not limited to a vertical direction and may be performed in any other direction.

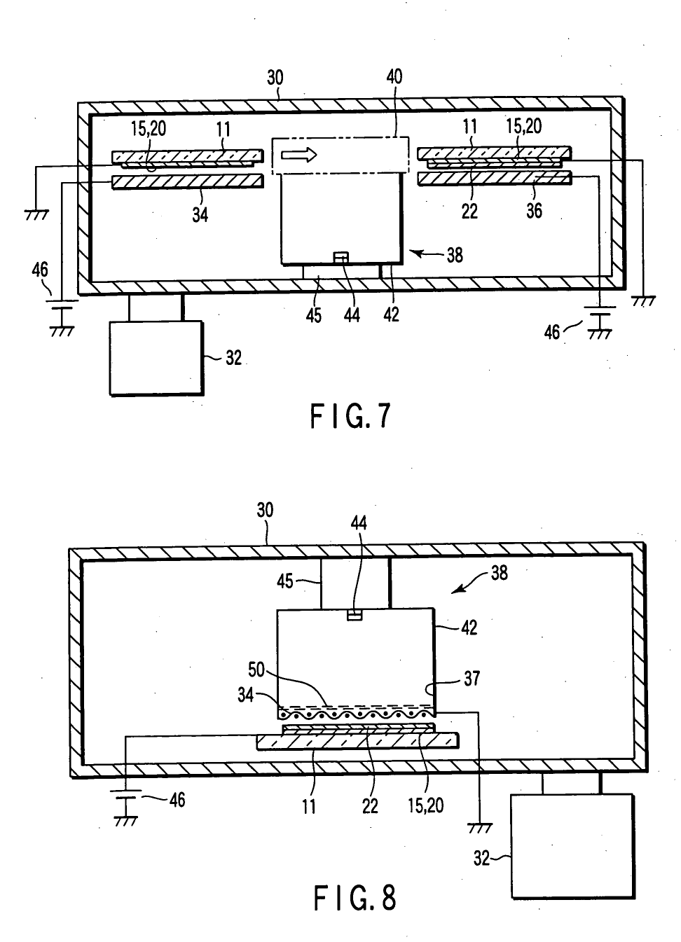

As in a fifth embodiment shown in FIG. 7, voltage may be applied from a power source 46 to the processing electrodes 34 and 36 themselves with the substrate side kept at the ground potential as the electric field processing is performed. According to this arrangement, high voltage can be applied, so that the effect of the electric field processing can be enhanced. If a negative potential is applied to the processing electrodes 34 and 36, for example, then it can be believed that a positive potential is applied to a front substrate 11 or a rear substrate 12. Accordingly, there is a merit that effects similar to those of the foregoing embodiments can be obtained and high voltage can be applied. It is to be understood that the same effects can be also obtained if a positive potential is applied to the processing electrodes.

Other configurations of the second to fifth embodiments are the same as those of the foregoing first embodiment, so that like reference numerals are used to designate like portions, and a detailed description of those portions is omitted.

The following is a description of a manufacturing apparatus and a manufacturing method for an FED according to a sixth embodiment of this invention. As shown in FIG. 8, the manufacturing apparatus is provided with a vacuum chamber 30 that is formed of a vacuum processing tank, and the vacuum chamber is connected with an exhaust pump 32 that evacuates its interior.

A getter device 38 for forming a getter film is located in the vacuum chamber 30. The getter device 38 comprises a substantially box-shaped cover 42 that has an opening 37 at its lower end. A getter material 44 is provided on a ceiling wall in the cover 42 and faces the opening 37. Further, the getter device 38 is provided with a heating mechanism 45 for heating the getter material 44. A heating mechanism of the high-frequency heating type or resistance heating type may be used as the heating mechanism 45.

The opening 37 of the cover 42 is formed having a size substantially equal to that of a substrate to be processed. A processing electrode 34 is provided so as to cover the opening 37 and attached to the cover 42. A large number of through holes for the passage of the getter are formed covering the whole processing electrode 34 and constitute an aperture portion.

The manufacturing apparatus comprises a power source 46 and a substrate transportation mechanism (not shown). The power source 46 applies voltage to the substrate to be processed. In the vacuum chamber 30, the substrate transportation mechanism transports the substrate to a processing position, that is, electric field processing position and a getter vapor deposition position, where the substrate faces the processing electrode 34.

When the processed substrate is located in the processing position where it faces the processing electrode 34, the space between the getter material 44 and the processing electrode is set wider than the space between the processing electrode and the processed substrate.

The following is a description of a method of processing the substrate by the aforesaid manufacturing apparatus. In the case described below, the substrate to be processed is a front substrate 11 on which a phosphor screen 15 and a metal back 20 are formed.

First, as shown in FIG. 8, the interior of the vacuum chamber 30 is evacuated to a desired degree of vacuum by the exhaust pump 32, whereupon a vacuum atmosphere is formed in the vacuum chamber. Subsequently, the front substrate 11 is carried into the vacuum chamber 30 and set in the processing position illustrated. In the processing position, the entire surface of the front substrate 11 on the side of the metal back 20 is opposed to the processing electrode 34 with a desired gap between them.

Then, the power source 46 that serves as an electric field applying section is connected electrically to the metal back 20, and voltage is applied from the power source 46 to the metal back. When this is done, the processing electrode 34 is connected to the ground potential. The voltage applied to the metal back 20 is set so that a positive or negative potential difference is caused between the metal back and the processing electrode 34. Thereupon, an electric field is generated between the front substrate 11 and the processing electrode 34, and the front substrate 11 is electric field-processed. By this electric field processing, foreign matter, such as dust, having so far been left on the front substrate 11 is adsorbed and removed by the processing electrode 34, and useless projections and the like that are formed in the process of production of the front substrate are removed.

After the electric field processing is completed, the front substrate 11 is moved to a position where it never faces the processing electrode 34 without failing to keep the potential difference between the processing electrode 34 and the front substrate 11. Accordingly, the foreign matter adsorbed by the processing electrode 34 or the removed projections can be held on the processing electrode lest the foreign matter or the removed projections fall onto and adhere again to the front substrate 11. When no potential difference is given after the electric field processing, moreover, the foreign matter, projections, etc. that are adsorbed by the processing electrode 34 or removed fall into the vacuum chamber 30, not onto the front substrate 11. Thus, the foreign matter or removed projections can be prevented from falling onto the substrate when the substrate is transported again.

Then, the entire surface of the front substrate 11 on the side of the metal back 20 is opposed again to the processing electrode 34 with the desired gap between them. The getter material 44 on the ceiling wall of the cover 42 is heated to be vaporized by the heating mechanism 45, whereby getter flashing is performed. In this manner, a part of the getter is vapor-deposited on that region of the processing electrode 34 in which no through holes are formed, thereby forming a getter film 50. The remaining part of the getter passes through the through holes of the processing electrode 34, and is vapor-deposited on the metal back 20 of the front substrate 11 to form a getter film 22.

When this is done, the space between the front substrate 11 and the processing electrode 34 is set smaller than the space between the processing electrode and the getter material 44. The conductance between the front substrate 11 and the processing electrode 34 is smaller than the conductance between the processing electrode and the getter material 44. Therefore, gas that is released from the getter material 44 during the getter flashing first passes through the processing electrode 34 and is adsorbed by the getter film 50 on this processing electrode without reaching the front substrate 11. Thus, the getter film 22 on the front substrate 11 can never be degraded by the gas.

After the getter film 22 is formed, voltage is applied from the power source 46 to the metal back 20 and the getter film 22. The applied voltage is set so that a positive or negative potential difference is caused between the front substrate 11 and the processing electrode 34. Thereupon, an electric field is generated between the front substrate 11 and the processing electrode 34, and the front substrate 11 is field-processed again. By the electric field processing, foreign matter, such as dust, adhering to the front substrate 11, including dust that is produced in a getter vapor deposition process or suspended matter in the vacuum chamber 30, is adsorbed and removed by the processing electrode 34, and useless projections and the like that are formed on the front substrate in the getter vapor deposition process are removed.

Thereafter, the front substrate 11 is moved to a position where it never faces the processing electrode 34 without failing to keep the potential difference between the front substrate 11 and the processing electrode 34. Thereupon, the electric field processing of the front substrate 11 and the getter film formation are finished.

On the other hand, the rear substrate 12, on which the wires 21, electron emitting elements 18, etc. are formed, is electric field-processed by the same aforesaid processes except the getter vapor deposition. However, the rear substrate 12 must only be electric field-processed at least once.

The electric field-processed front and rear substrates 11 and 12 are transported to a sealing position (not shown) in a manner such that they are kept in a vacuum atmosphere without being exposed to the open air, and are then sealed together to form a vacuum envelope 10. Thereupon, the vacuum envelope of an FED is completed. The substrates may be sealed either in the same vacuum chamber as the vacuum chamber 30 for the aforesaid electric field processing or in another vacuum chamber that communicates with the vacuum chamber 30 in a vacuum state.

According to the manufacturing method and the manufacturing apparatus arranged in this manner, dust or other foreign matter adhering to the front substrate 11 and the rear substrate 12 and useless projections and the like that are formed in the process of production of the front substrate and the rear substrate can be removed by electric field processing before the substrates are put into the vacuum chamber. After these substrates are put into the vacuum chamber, moreover, foreign matter, such as dust, adhering to the substrates, including dust that is produced in the getter vapor deposition process or suspended matter in the vacuum chamber, can be removed by electric field processing. Accordingly, factors that trigger generation of electric discharge can be eliminated, so that the FED with improved withstand voltage characteristics can be obtained. After the electric field processing of the front substrate and the rear substrate and the getter vapor deposition process are carried out in the vacuum chamber, in particular, the vacuum envelope is formed without exposing these substrates to the open air. By doing this, suppression of initial electric discharge and prolonged electric discharge can be realized without the possibility of dust or the like in the open air adhering again to the substrates.

In consequence, breakdown and degradation of a phosphor screen and electron emitting elements and breakdown of a driver circuit can be prevented from being caused by electric discharge, so that the reliability and life performance of the FED can be improved. At the same time, the anode potential can be set higher, so that the FED can be obtained having high luminance and high display performance. Further, the gas adsorption properties of the getter film on the front substrate 11 can be prevented from lowering, so that a high degree of vacuum can be maintained for a prolonged time to ensure production of a long-life product.

Owing to the presence of the aperture portion in the processing electrode, moreover, the electric field processing and the getter film vapor deposition can be carried out with the processed substrate held in the same position. Thus, the processing processes and the manufacturing apparatus can be simplified. The getter film is also formed on that region of the processing electrode which is not provided with the aperture portion, so that the gas that is generated during the getter flashing can be adsorbed by the getter film. In consequence, the getter film formed on the front substrate can maintain its high gas adsorption properties without being degraded.

According to the sixth embodiment described above, the electric field processing is performed twice before and after the vapor deposition of the getter film. Alternatively, however, the electric field processing of the front substrate 11 may be performed only after the getter film is formed. Also in this case, the getter film 22 that is finally exposed in the vacuum envelope and faces the rear substrate 12 is electric field-processed, whereby dust or other foreign matter adhering to the getter film and useless projections and the like that are formed in the manufacturing process can be removed. In consequence, the withstand voltage characteristics of the FED can be fully improved, and functions and effects similar to those of the foregoing embodiments can be obtained. Alternatively, the electric field processing may be performed only before the vapor deposition of the getter film. Also in this case, the withstand voltage characteristics can be improved.

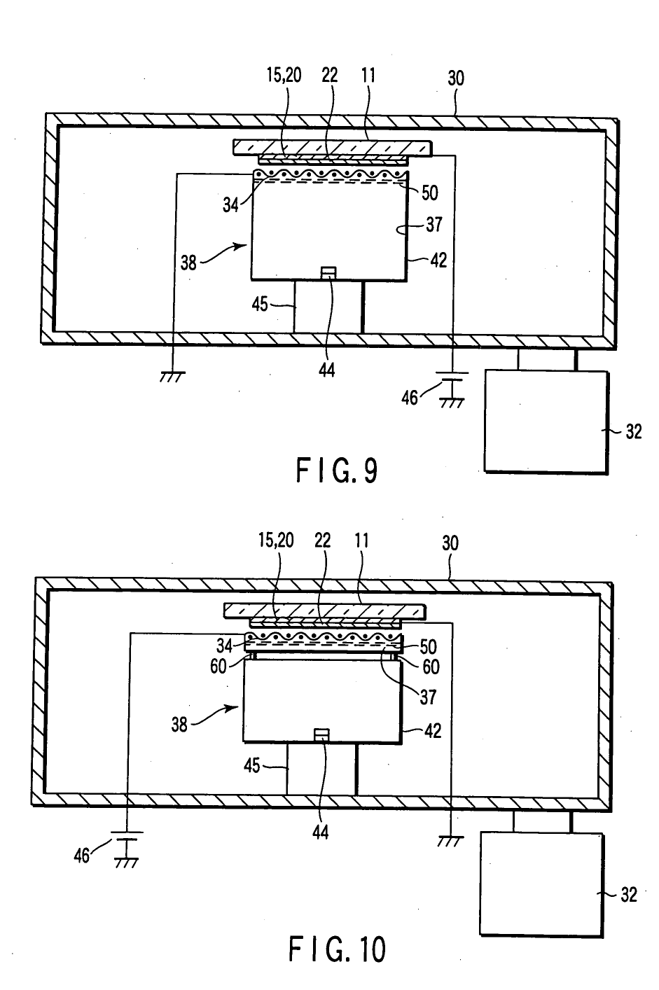

In the sixth embodiment described above, the getter flashing is effected from top to bottom using the getter material 44 that is located above the processed substrate. As in a seventh embodiment shown in FIG. 9, however, a getter material 44 may be located below a processed substrate so that getter flashing is performed from bottom to top. In this case, adhesion of dust that is produced by the getter flashing to the substrate can be reduced more securely. It is to be understood that the getter flashing is not limited to a vertical direction and may be performed in any other direction.

According to an eighth embodiment shown in FIG. 10, a processing electrode 34 is supported floating over a cover 42 by an insulating member, such as an insulator 60. A power source 46 is connected electrically to the processing electrode 34, and a metal back of a front substrate 11 is connected to the ground potential. According to this arrangement, high voltage can be applied to the processing electrode 34 itself, so that the effect of electric field processing can be enhanced. If a negative potential is applied to the processing electrode 34, for example, then it can be believed that a positive potential is applied to a front substrate 11 or a rear substrate 12. Accordingly, there is a merit that effects similar to those of the foregoing embodiments can be obtained and high voltage can be applied. It is to be understood that the same effects can be also obtained if a positive potential is applied to the processing electrode 34.

Other configurations of the seventh and eighth embodiments are the same as those of the foregoing sixth embodiment, so that like reference numerals are used to designate like portions, and a detailed description of those portions is omitted.

This invention is not limited to the embodiments described above, and various modifications may be effected therein without departing from the scope of the invention. In the foregoing embodiments, for example, the processing electrodes are formed having substantially the same shape as the substrate to be processed. Alternatively, however, a processing electrode that is smaller in size than the substrate may be used so that the entire surface of the substrate can be electric field-processed by relatively moving the processing electrode and the substrate.

In the foregoing embodiments, moreover, both the front substrate and the rear substrate are electric field-processed in a vacuum atmosphere. Alternatively, however, an image display device with improved withstand voltage characteristics can be also obtained by electric field processing at least one of the substrates. This invention may be also applied to any other image display devices than FEDs.

1. A method of manufacturing an image display device, which has a front substrate having a phosphor screen formed thereon and a rear substrate provided with a plurality of electron emitting elements, the method comprising:
opposing at least one of the front and rear substrates to a processing electrode in a vacuum atmosphere and applying an electric field between the at least one substrate and the processing electrode, thereby electric field processing the at least one substrate; and
sealing together the front substrate and the rear substrate kept in the vacuum atmosphere after the electric field processing.

2. The method of manufacturing an image display device according to claim 1, wherein the electric field processing is performed after a getter film is formed on a phosphor screen side of the front substrate by getter flashing in the vacuum atmosphere.

3. The method of manufacturing an image display device according to claim 1, wherein a getter film is formed on a phosphor screen side of the front substrate by getter flashing in the vacuum atmosphere before the sealing after the electric field processing is performed.

4. The method of manufacturing an image display device according to claim 1, wherein a getter film is formed on a phosphor screen side of the front substrate by getter flashing after the electric field processing is performed in the vacuum atmosphere, and the electric field processing is performed again for the front substrate having the getter film formed thereon.

5. A method of manufacturing an image display device, which has a front substrate having a phosphor screen formed thereon and a rear substrate provided with a plurality of electron emitting elements, the method comprising:
forming a getter film on a phosphor screen side of the front substrate by getter flashing in a vacuum atmosphere;
opposing a getter film side of the front substrate to a processing electrode and applying an electric field between the front substrate and the processing electrode, thereby electric field processing the front substrate; and
sealing together the rear substrate and the field-processed front substrate kept in the vacuum atmosphere.

6. A method of manufacturing an image display device, which has a front substrate having a phosphor screen formed thereon and a rear substrate provided with a plurality of electron emitting elements, the method comprising:
opposing a phosphor screen side of the front substrate to a processing electrode in a vacuum atmosphere, applying an electric field between the front substrate and the processing electrode, thereby electric field processing the front substrate, and then forming a getter film on the phosphor screen side of the field-processed front substrate by getter flashing in a vacuum atmosphere; and
sealing together the rear substrate and the front substrate having the getter film formed thereon and kept in the vacuum atmosphere.

7. The method of manufacturing an image display device according to claim 6, wherein the getter film on the front substrate and the processing electrode are opposed to each other, the electric field is applied between the front substrate and the processing electrode to electric field-process the front substrate, and the front substrate kept in the vacuum atmosphere is then sealed to the rear substrate.

8. The method of manufacturing an image display device according to claim 6, wherein the getter film is formed by vaporizing a getter material located below the front substrate in the vacuum atmosphere.

9. A method of manufacturing an image display device, which has a front substrate having a phosphor screen formed thereon and a rear substrate provided with a plurality of electron emitting elements, the method comprising:
opposing the front substrate and a processing electrode having an aperture portion to each other in a vacuum atmosphere and applying an electric field between the front substrate and the processing electrode, thereby electric field processing the front substrate; and
sealing together the front substrate and the rear substrate kept in the vacuum atmosphere after the electric field processing.

10. The method of manufacturing an image display device according to claim 9, wherein the electric field processing is performed after effecting getter flashing through the processing electrode in the vacuum atmosphere, thereby forming a getter film on a phosphor screen side of the front substrate.

11. The method of manufacturing an image display device according to claim 9, wherein a getter film is formed on a phosphor screen side of the front substrate by getter flashing through the processing electrode in the vacuum atmosphere before the sealing after the electric field processing is performed.

12. The method of manufacturing an image display device according to claim 9, wherein a getter film is formed on a phosphor screen side of the front substrate by getter flashing through the processing electrode after the electric field processing is performed in the vacuum atmosphere, and the electric field processing is performed again for the front substrate having the getter film formed thereon.

13. The method of manufacturing an image display device according to claim 10, wherein the getter film is formed on the processing electrode by the getter flashing.

14. The method of manufacturing an image display device according to claim 10, wherein the getter flashing is effected with a conductance between a getter material for the getter flashing and the processing electrode set larger than a conductance between the processing electrode and the front substrate.

15. An apparatus for manufacturing an image display device, which has a front substrate having a phosphor screen formed thereon and a rear substrate provided with a plurality of electron emitting elements, the apparatus comprising:
a vacuum chamber of which the interior is kept in a vacuum and which stores at least one of the front and rear substrates;
a processing electrode located opposite to the at least one substrate in the vacuum chamber;
an electric field applying section which applies an electric field between the at least one substrate and the processing electrode; and
a getter device which is provided in the vacuum chamber and forms a getter film on the at least one substrate.

16. An apparatus for manufacturing an image display device, which has a front substrate having a phosphor screen formed thereon and a rear substrate provided with a plurality of electron emitting elements, the apparatus comprising:
a vacuum chamber of which the interior is kept in a vacuum and which can store the front substrate;
a processing electrode located opposite to the front substrate in the vacuum chamber; and
an electric field applying section which applies an electric field between the front substrate and the processing electrode.

17. The apparatus for manufacturing an image display device according to claim 16, further comprising a getter device which is located opposite to the front substrate with the processing electrode therebetween in the vacuum chamber and forms a getter film on the front substrate.

18. The apparatus for manufacturing an image display device according to claim 17, wherein the getter device is provided with a getter material located opposite to the front substrate with the processing electrode therebetween, and a conductance between the getter material and the processing electrode is set larger than a conductance between the processing electrode and the front substrate.
